(19) United States
(12) Patent Application Publication
(10) Pub. No.: US 2024/0415256 A1
(43) Pub. Date: Dec. 19, 2024

(54) SUITCASE BODY TO HOLD MASSAGER AND SUITCASE WITH MASSAGER

(71) Applicant: Changhu ZHAN, Shenzhen, Guangdong (CN)

(72) Inventor: Changhu ZHAN, Shenzhen, Guangdong (CN)

(21) Appl. No.: 18/815,838

(22) Filed: Aug. 27, 2024

(30) Foreign Application Priority Data
Aug. 19, 2024 (CN) 202411134918.5

(51) Int. Cl. A45C 13/02; A45C 5/03; A45C 5/14; A45C 13/26; A61H 19/00

(52) U.S. Cl. CPC A45C 13/02; A45C 5/03; A45C 5/14; A45C 13/262; A45C 2013/267; A61H 19/32

(57) ABSTRACT

A suitcase body to hold a massager. The suitcase body includes a first housing and a second housing. A first end of the first housing is rotatably connected to a first end of the second housing, the first housing is provided with a first containing groove, the second housing is provided with a second containing groove, the first containing groove is configured for being inserted a lower part of the massager, the second containing groove is configured for being inserted an upper part of the massager, and when the second housing covers the first housing, the first containing groove and the second containing groove are connected and form a containing space for holding the massager.

### CROSS-REFERENCE TO RELATED APPLICATIONS

The application claims priority of Chinese patent application CN2024111349185, filed on Aug. 19, 2024, which is incorporated herein by reference in its entireties.

### TECHNICAL FIELD

The present disclosure relates to the field of containing devices, in particular to a suitcase body to hold a massager and a suitcase with a massager.

### BACKGROUND

The adult massager, as a massager in the sexual life of men and women, is an interesting massager which achieves sexual pleasure by massaging the whole body or part of the human body. With the emancipation of people's minds, more and more consumers choose to purchase and use this kind of massager.

However, when users transport and store adult massagers, it is easy for others to accidentally find such products, which inevitably causes embarrassment; especially in the army and schools, people have a low degree of privacy protection; even in their own homes, they may be accidentally found by visitors and children. At present, the existing adult massagers on the market generally use independent packages to avoid privacy disclosure, but such packages are difficult to reuse after disassembly, and their containing devices are generally special and easy to be noticed by others.

Therefore, the invention provides a suitcase body to hold a massager and a suitcase with a massager, which can effectively solve the problems, have simple structure and convenient use, and be able to effectively protect the privacy of users and avoid attracting the attention of others.

### SUMMARY

In order to overcome the shortcomings of the prior art, the present disclosure provides a suitcase body to hold, which have simple structure and convenient use, and be able to effectively protect the privacy of users and avoid attracting the attention of others.

The technical solution adopted by the present disclosure to solve the technical problem is as follows.

A suitcase body to hold a massager, includes a first housing; and a second housing, wherein a first end of the first housing is rotatably connected to a first end of the second housing, the first housing is provided with a first containing groove, the second housing is provided with a second containing groove, the first containing groove is configured for being inserted a lower part of the massager, the second containing groove is configured for being inserted an upper part of the massager, and when the second housing covers the first housing, the first containing groove and the second containing groove are connected and form a containing space for holding the massager.

As an improvement of the present disclosure, a second end of the first housing is provided with a locking device, a second end of the second housing is provided with a locking hole, a locking block of the locking device is detachably connected to the locking hole.

As an improvement of the present disclosure, the locking device includes an unlock button, the unlock button is configured to drive the locking block to be detached from the locking hole by an external force.

As an improvement of the present disclosure, the locking device includes a password adjusting part, the password adjusting part is configured to lock or release the unlock button.

As an improvement of the present disclosure, the suitcase body further includes a handle, the handle is arranged at the second end of the first housing and is configured for the user to grip.

As an improvement of the present disclosure, a first roller is arranged on one side of the first end of the first housing away from the second housing, and a second roller is arranged on one side of the first end of the second housing away from the first housing.

As an improvement of the present disclosure, the suitcase body further includes a pull rod, a pull rod groove is arranged on one side of the first housing away from the second housing, the pull rod is slidably arranged in the pull rod groove, and is configured to penetrate into or out along the second end of the first housing.

As an improvement of the present disclosure, the pull rod includes a handle and a rod body, the first housing is provided with a handle groove adjacent to the pull rod groove, the rod body is configured to slide in the pull rod groove, and the handle is detachably accommodated in the handle groove.

As an improvement of the present disclosure, a diameter of a middle of the handle is greater than a diameter of each of two ends of the handle.

The present disclosure further provides a suitcase with a massager, includes the massager and a suitcase body, wherein a first end of the first housing is rotatably connected to a first end of the second housing, the first housing is provided with a first containing groove, the second housing is provided with a second containing groove, the first containing groove is configured for being inserted a lower part of the massager, the second containing groove is configured for being inserted an upper part of the massager, and when the second housing covers the first housing, the first containing groove and the second containing groove are connected and form a containing space for holding the massager, the shape of the first containing groove matches the shape of the lower part of the massager, and the shape of the second containing groove matches the shape of the upper part of the massager.

As an improvement of the present disclosure, a second end of the first housing is provided with a locking device, a second end of the second housing is provided with a locking hole, a locking block of the locking device is detachably connected to the locking hole.

As an improvement of the present disclosure, the locking device includes an unlock button, the unlock button is configured to drive the locking block to be detached from the locking hole by an external force.

As an improvement of the present disclosure, the locking device includes a password adjusting part, the password adjusting part is configured to lock or release the unlock button.

As an improvement of the present disclosure, the suitcase further includes a handle, the handle is arranged at the second end of the first housing and is configured for the user to grip.

As an improvement of the present disclosure, a first roller is arranged on one side of the first end of the first housing away from the second housing, and a second roller is arranged on one side of the first end of the second housing away from the first housing.

As an improvement of the present disclosure, the suitcase further includes a pull rod, a pull rod groove is arranged on one side of the first housing away from the second housing, the pull rod is slidably arranged in the pull rod groove, and is configured to penetrate into or out along the second end of the first housing.

As an improvement of the present disclosure, the pull rod includes a handle and a rod body, the first housing is provided with a handle groove adjacent to the pull rod groove, the rod body is configured to slide in the pull rod groove, and the handle is detachably accommodated in the handle groove.

As an improvement of the present disclosure, a diameter of a middle of the handle is greater than a diameter of each of two ends of the handle.

Beneficial effects: Through the arrangement of the above structure, when in use, a user is able to insert the lower part of the massager into the first containing groove and cover the second housing, so that the upper part of the massager is inserted into the second containing groove, effectively containing and shielding the product of the massager. On the one hand, the cleanliness of the product of the massager can be ensured. On the other hand, the massager is able to be hidden in the suitcase, making it less likely to be noticed when the products are transported and stored. The privacy of the user is effectively protected, and the embarrassing situation where the massager is accidentally discovered by someone is avoided.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a schematic diagram of the overall structure of a first embodiment of the present invention in the closed state;

FIG. 2 is a schematic diagram of the overall structure of the first embodiment of the present invention in the opened state;

FIG. 3 is a schematic diagram of the exploded structure of the first embodiment of the present invention in the closed state;

FIG. 4 is a schematic diagram of the structure of the first embodiment of the present invention in the state of the pull rod being stretched;

FIG. 5 is a schematic sectional structure diagram of the first embodiment of the present invention;

FIG. 6 is a schematic diagram of the partial structure of a second embodiment of the present invention.

### DETAILED DESCRIPTION OF THE EMBODIMENTS

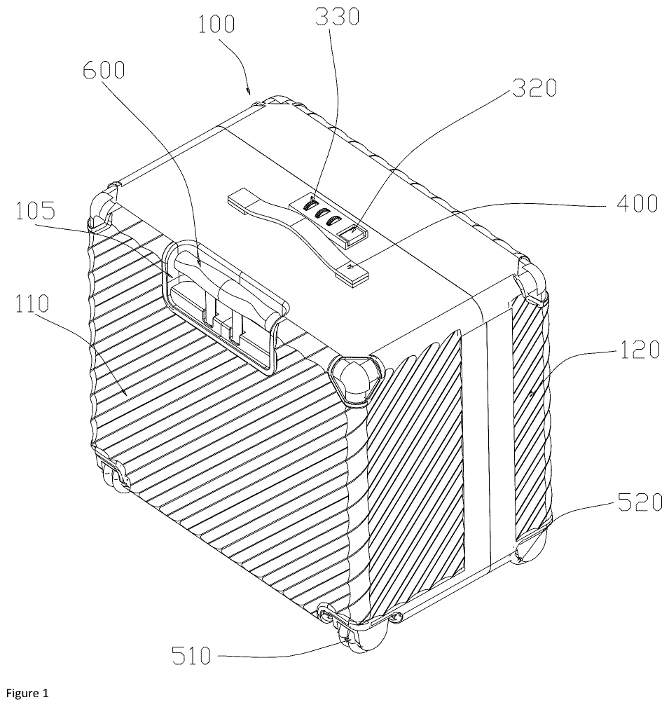

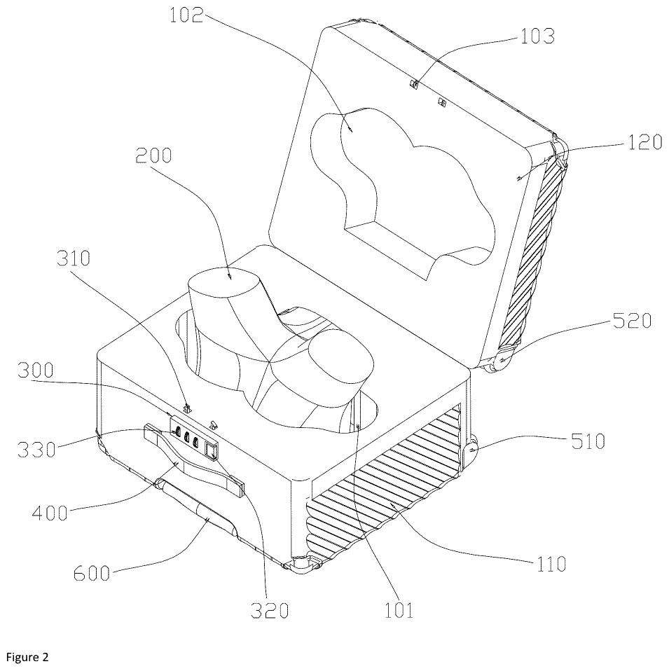

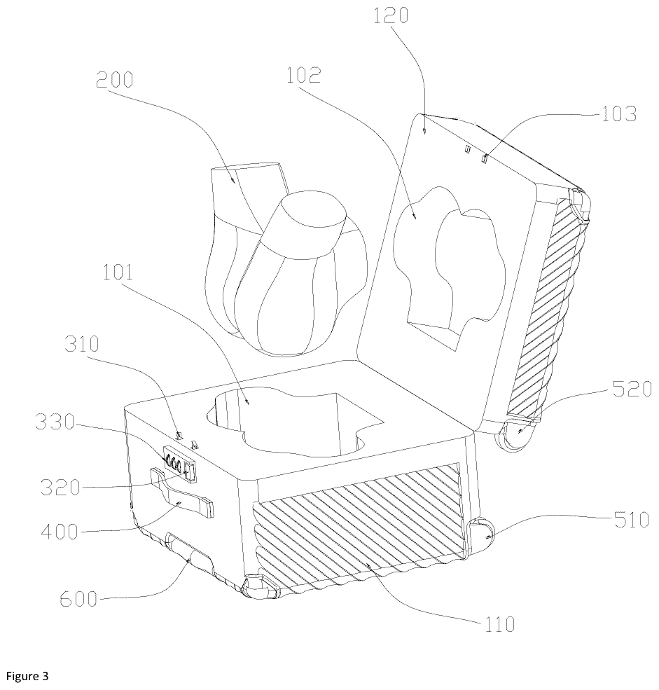

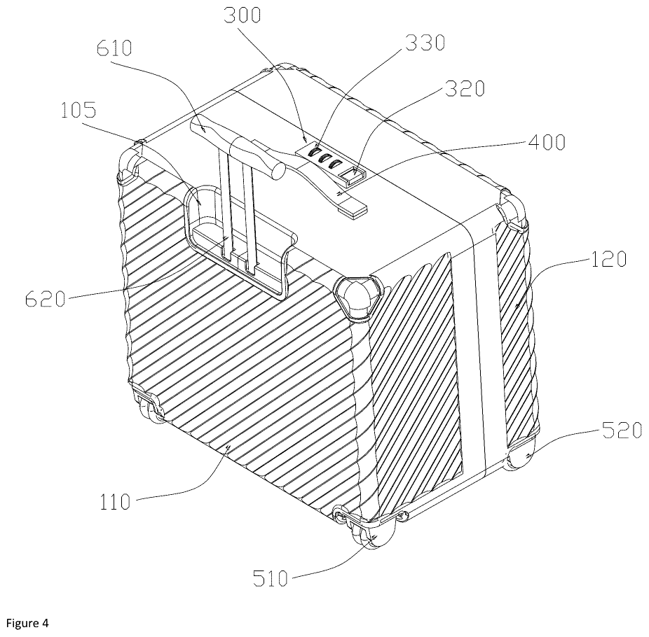

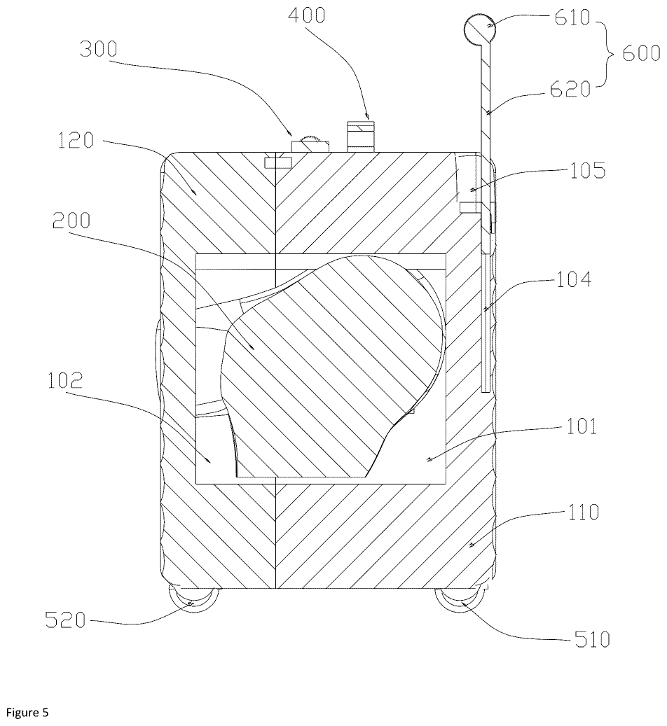

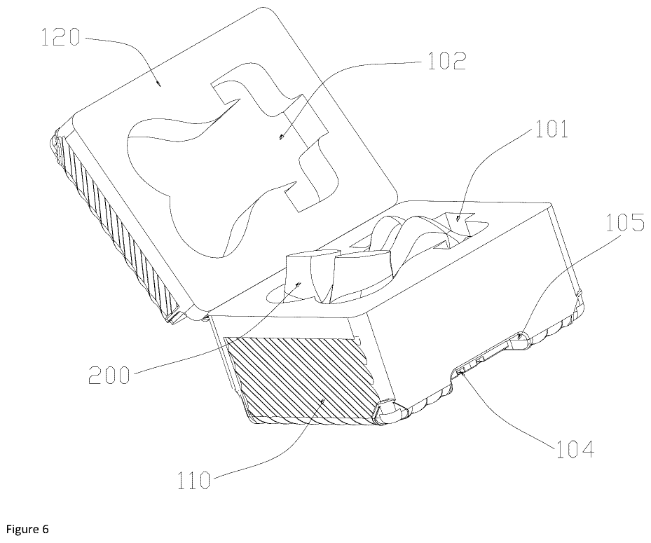

Referring to FIG. 1 to FIG. 6, a suitcase with a massager includes a suitcase body 100 and the massager 200, wherein the suitcase body 100 includes a first housing 110 and a second housing 120, a first end of the first housing 110 is rotatably connected to a first end of the second housing 120, the first housing 110 is provided with a first containing groove 101, the second housing 120 is provided with a second containing groove 102, the first containing groove 101 is configured for being inserted a lower part of the massager 200, the second containing groove 102 is configured for being inserted an upper part of the massager 200, and when the second housing 120 covers the first housing 110, the first containing groove 101 and the second containing groove 102 are connected and form a containing space for completely holding the massager 200.

Through the arrangement of the above structure, when in use, a user is able to insert the lower part of the massager 200 into the first containing groove 101 and cover the second housing 120, so that the upper part of the massager 200 is inserted into the second containing groove 102, effectively containing and shielding the product of the massager 200. On the one hand, the cleanliness of the product of the massager 200 can be ensured. On the other hand, the massager 200 is able to be hidden in the suitcase, making it less likely to be noticed when the products are transported and stored. The privacy of the user is effectively protected, and the embarrassing situation where the massager 200 is accidentally discovered by someone is avoided.

In this embodiment, a second end of the first housing 110 is provided with a locking device 300, a second end of the second housing 120 is provided with a locking hole 103, a locking block 310 of the locking device 300 is detachably connected to the locking hole 103. Through the arrangement of the above structure, when in use, the locking block 310 is locked in the locking hole 103, enabling the second ends of the first housing 110 and the second housing 120 to be locked together. This prevents the suitcase body 100 from being opened accidentally, further ensuring the stability of the product and safeguarding the user's privacy from being disclosed. When opening the second housing 120, detach the locking block 310 from the locking hole 103 to open the suitcase body 100, thereby enabling the user to conveniently take and clean the massager 200.

In this embodiment, the locking device 300 includes an unlock button 320, the unlock button 320 is configured to drive the locking block 310 to be detached from the locking hole 103 by an external force. Through the arrangement of the above structure, when in use, the user is able to press the unlock button 320, and the unlock button 320 drives the locking block 310 to detach from the locking hole 103, so that the second end of the first housing 110 is separated from the second end of the second housing 120, and the user is able to conveniently open the suitcase body 100, it is convenient to use and simple to operate.

In this embodiment, the locking device 300 includes a password adjusting part 330, the password adjusting part 330 is configured to lock or release the unlock button 320. Through the arrangement of the above structure, when in use, the password adjusting part 330 makes the real-time password the same as the preset password, at this time, the password adjusting part 330 releases the unlock button 320. Then, by the user pressing the unlock button 320, the locking block 310 is able to be detached from the locking hole 103. So that the second housing 120 and the first housing 110 are separated, and the suitcase body 100 is opened. However, when locking is required, the password adjusting part 330 makes the real-time password different from the preset password and locks the unlock button 320. At this time, the locking block 310 is inserted into the locking hole 103 to fix the second housing 120 and the first housing 110, effectively preventing the suitcase body 100 from being opened accidentally and protecting the user's privacy.

In this embodiment, further a handle 400 is included. The handle 400 is arranged at the second end of the first housing 110. The handle 400 is configured for the user to grip and use. When in use, the user is able to grip the handle 400, which is convenient for the user to pick up and transport the product. It is more convenient to use, improves the portability of the product, and provides a better user experience.

In this embodiment, a first roller 510 is arranged on one side of the first end of the first housing 110 away from the second housing 120, and a second roller 520 is arranged on one side of the first end of the second housing 120 away from the first housing 110. Through the arrangement of the above structure, the first roller 510 is arranged at a bottom of the first house 110, the second roller 520 is arranged at a bottom of the second housing 120. When in use, the first roller 510 and the second roller 520 are in contact with the ground, and a user is able to push or pull a product, so that the product is able to be moved in a more labor-saving manner, and the user is able to use the product more conveniently.

In this embodiment, further a pull rod 600 is included, a pull rod groove 104 is arranged on one side of the first housing 110 away from the second housing 120, the pull rod 600 is slidably arranged in the pull rod groove 104, and is configured to penetrate into or out along the second end of the first housing 110. Through the arrangement of the above structure, when in use, the pull rod 600 is able to be partially pulled out from the pull rod groove 104. The user is able to adjust the height of the end of the pull rod 600, this makes the user to pull the product conveniently and results in greater ease of use. However, when storing, the pull rod 600 is basically completely inserted into the pull rod groove 104, reducing the overall length of the product and decreasing the product volume, which is convenient for storage and transportation. Preferably, the pull rod 600 is provided with a spring buckle, and several locking positions are provided in the pull rod groove 104. The spring buckle is clamped to different locking positions, which can adjust the extended length of the pull rod 600, this makes the product structure is stable.

In this embodiment, the pull rod 600 includes a handle 610 and a rod body 620, the first housing 110 is provided with a handle groove 105 adjacent to the pull rod groove 104, the rod body 620 is configured to slide in the pull rod groove 104, and the handle is detachably accommodated in the handle groove 105. Through the arrangement of the above structure, the user is able to pull or press the handle 610 to make the rod body 620 extend or retract. This is convenient for the user to adjust the extension length of the pull rod 600. When pulling the product, the handle 610 is also convenient for the user to hold, making it even more convenient for users. During storage, the handle 610 is pressed down so that the rod body 620 is substantially completely inserted into the pull rod groove 104. At the same time, the handle 610 is accommodated in the handle groove 105, thereby effectively reducing the volume of the product.

In this embodiment, a diameter of a middle of the handle 610 is greater than a diameter of each of two ends of the handle 610. Through the arrangement of the above structure, a diameter of a middle of the handle 610 is greater than a diameter of each of two ends of the handle 610, when the user holds the handle 610, the hand feel is more comfortable and the user experience is better.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

1. A suitcase body to hold a massager, comprising
a first housing; and
a second housing,
wherein a first end of the first housing is rotatably connected to a first end of the second housing, the first housing is provided with a first containing groove, the second housing is provided with a second containing groove, the first containing groove is configured for being inserted a lower part of the massager, the second containing groove is configured for being inserted an upper part of the massager, and when the second housing covers the first housing, the first containing groove and the second containing groove are connected and form a containing space for holding the massager.

2. The suitcase body according to claim 1, wherein a second end of the first housing is provided with a locking device, a second end of the second housing is provided with a locking hole, a locking block of the locking device is detachably connected to the locking hole.

3. The suitcase body according to claim 2, wherein the locking device comprises an unlock button, the unlock button is configured to drive the locking block to be detached from the locking hole by an external force.

4. The suitcase body according to claim 3, wherein the locking device comprises a password adjusting part, the password adjusting part is configured to lock or release the unlock button.

5. The suitcase body according to claim 1, further comprising a handle, wherein the handle is arranged at the second end of the first housing and is configured for the user to grip.

6. The suitcase body according to claim 1, wherein a first roller is arranged on one side of the first end of the first housing away from the second housing, and a second roller is arranged on one side of the first end of the second housing away from the first housing.

7. The suitcase body according to claim 1, further comprising a pull rod, wherein a pull rod groove is arranged on one side of the first housing away from the second housing, the pull rod is slidably arranged in the pull rod groove, and is configured to penetrate into or out along the second end of the first housing.

8. The suitcase body according to claim 7, wherein the pull rod comprises a handle and a rod body, the first housing is provided with a handle groove adjacent to the pull rod groove, the rod body is configured to slide in the pull rod groove, and the handle is detachably accommodated in the handle groove.

9. The suitcase body according to claim 7, wherein a diameter of a middle of the handle is greater than a diameter of each of two ends of the handle.

10. A suitcase with a massager, comprising
the massager and
a suitcase body,
wherein a first end of the first housing is rotatably connected to a first end of the second housing, the first housing is provided with a first containing groove, the second housing is provided with a second containing groove, the first containing groove is configured for being inserted a lower part of the massager, the second containing groove is configured for being inserted an upper part of the massager, and when the second housing covers the first housing, the first containing groove and the second containing groove are connected and form a containing space for holding the massager, the shape of the first containing groove matches the shape of the lower part of the massager, and the shape of the second containing groove matches the shape of the upper part of the massager.

11. The suitcase according to claim 10, wherein a second end of the first housing is provided with a locking device, a second end of the second housing is provided with a locking hole, a locking block of the locking device is detachably connected to the locking hole.

12. The suitcase according to claim 11, wherein the locking device comprises an unlock button, the unlock button is configured to drive the locking block to be detached from the locking hole by an external force.

13. The suitcase according to claim 12, wherein the locking device comprises a password adjusting part, the password adjusting part is configured to lock or release the unlock button.

14. The suitcase according to claim 10, further comprising a handle, wherein the handle is arranged at the second end of the first housing and is configured for the user to grip.

15. The suitcase according to claim 10, wherein a first roller is arranged on one side of the first end of the first housing away from the second housing, and a second roller is arranged on one side of the first end of the second housing away from the first housing.

16. The suitcase according to claim 10, further comprising a pull rod, wherein a pull rod groove is arranged on one side of the first housing away from the second housing, the pull rod is slidably arranged in the pull rod groove, and is configured to penetrate into or out along the second end of the first housing.

17. The suitcase according to claim 16, wherein the pull rod comprises a handle and a rod body, the first housing is provided with a handle groove adjacent to the pull rod groove, the rod body is configured to slide in the pull rod groove, and the handle is detachably accommodated in the handle groove.

18. The suitcase according to claim 17, wherein a diameter of a middle of the handle is greater than a diameter of each of two ends of the handle.
